(19) United States
(12) Patent Application Publication
(10) Pub. No.: US 2009/0110529 A1
(43) Pub. Date: Apr. 30, 2009

(54) PNEUMATIC TRANSFER OF FINELY GROUND CLAY MATERIAL

(75) Inventors: Neale Browne, Houston, TX (US); Mukesh Kapila, The Woodlands, TX (US); Wayne Matlock, Lafayette, LA (US)

Correspondence Address: OSHA LIANG/MI, TWO HOUSTON CENTER, 909 FANNIN STREET, SUITE 3500, HOUSTON, TX, 77010, US

(73) Assignee: M-I LLC, Houston, TX (US)

(21) Appl. No.: 12/178,392

(22) Filed: Jul. 23, 2008

Related U.S. Application Data
(63) Continuation-in-part of application No. 11/932,426, filed on Oct. 31, 2007.
Application No. 11/932,426 is a continuation-in-part of application No. PCT/US08/16360, filed on May 9, 2008.

(51) Int. Cl. B65G 53/10

(52) U.S. Cl. 414/676; 414/808

(57) ABSTRACT

A method for transferring a sized clay material for use in drilling fluids that includes providing the sized clay material to a pneumatic transfer vessel; supplying an air flow to the sized clay material in the pneumatic transfer vessel; and transferring the sized clay material from the pneumatic transfer vessel to a storage vessel is disclosed.

### CROSS-REFERENCE TO RELATED APPLICATIONS

This application is a continuation in-part of U.S. patent application Ser. No. 11/932,426, filed on Oct. 31, 2007, and International Application No. PCT/US08/16360, filed on May 9, 2008, both of which are herein incorporated by reference in their entirety.

### BACKGROUND

1. Field of the Disclosure

Embodiments disclosed herein relate generally to methods for transferring finely ground clay material. More particularly, the present disclosure relates to methods for treating finely ground clay material with chemical additives, and the pneumatic transfer of finely ground clay material.

2. Background Art

When drilling or completing wells in earth formations, various fluids typically are used in the well for a variety of reasons. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

One of the above-mentioned purposes includes the transportions of cuttings up to the earth's surface in addition to prevention of the settling of drill cuttings and weight material to the low-side or the bottom of the hole during periods of suspended drilling operations. This phenomenon of preventing the settling of solids within a wellbore fluid is due to the fluid's thixotropic properties. One of ordinary skill in the art should appreciate that without such thixotropic properties, the settling of solids within the fluid may result in the deposition of solids on the drill bit which may become “stuck” or, a reduction in the wellbore fluid density may result leading to a reservoir “kick” or, in the extreme case, a “blowout”—a catastrophic, uncontrolled inflow of reservoir fluids into the wellbore—may occur. A wellbore fluid, if maintained properly, can provide sufficient suspension capacity to counter the settling of solids.

A critical property of wellbore fluids in achieving these functions is viscosity, or the ratio of shearing stress to shearing strain. A wellbore fluid must have sufficient viscosity in order to lift the cuttings to the surface. The rate at which cuttings are removed from the wellbore is a function of the carrying capacity of the wellbore fluid, which depends directly on several factors including the density of the wellbore fluid, viscosity of the wellbore fluid, velocity profile, torque of the drillstring, size and shape of the solid particles, rotation of the drillstring, and the ratio of the specific gravity of solids to the wellbore fluid.

To increase the lifting capacity of the wellbore fluid (to suspend cuttings and weight materials), one may increase the gel strength of the wellbore fluids. To achieve such an increase in gel strength, a variety of methods exist. One method includes adding gelling agents such as bentonite (sodium montmorillonite), attapulgite, or sepiolite, purposely to impart rheological properties to water-base fluids. In addition to clays, one may also add a soluble polymer such as xanthan gum, guar gum, carboxymethyl cellulose, hydroxyethyl cellulose, or synthetic polymers to enhance fluid viscosity. Another method is incorporating natural clays encountered during the drilling of argillaceous (clayey) formations into the wellbore fluid.

Frequently, various types of clay are added to a fluid formulation to give viscosity and enhance the rheological properties of the fluid. Clay possesses a structure of silica-alumina lattices, which are arranged in multiple layers, sometimes with other species such as magnesium or calcium incorporated into the lattices. Water molecules enter the lattice structure and bond with active sites, causing the layers to expand or eventually disperse into individual particles. Dispersion of clay increases the surface area which in turns causes the clay-water site to expand, and the clay-water suspension to thicken. Clays are thus often referred to as gelling agents, and are used to impart viscosity, density, sealing, and thixotropic properties to contribute to the stability of the borehole.

Accordingly, there exists a continuing need for developments in the use of clay materials in wellbore fluids.

### SUMMARY OF INVENTION

In one aspect, embodiments disclosed herein relate to a method for transferring a sized clay material for use in drilling fluids that includes providing the sized clay material to a pneumatic transfer vessel; supplying an air flow to the sized clay material in the pneumatic transfer vessel; and transferring the sized clay material from the pneumatic transfer vessel to a storage vessel.

In another aspect, embodiments disclosed herein relate to method for transferring a sized clay material for use in drilling fluids that includes modifying a particle size distribution of the sized clay material; sealing the sized clay material in a pneumatic transfer vessel; supplying an air flow to the sized clay material in the pneumatic transfer vessel; and transferring the sized clay material from the pneumatic transfer vessel to a storage vessel.

In yet another aspect, embodiments disclosed herein relate to a system for transferring a sized clay material for use in drilling fluids that includes a first pneumatic vessel configured to supply a flow of chemically treated sized clay material comprising d₅₀<50 microns in size; and a second pneumatic vessel in fluid communication with the first pneumatic vessel and configured to receive the flow of chemically treated sized clay material from the first pneumatic vessel.

In yet another aspect, embodiments disclosed herein relate to a method of transferring a sized clay material that includes providing the sized clay material to a pneumatic transfer vessel, wherein the sized clay material comprises a modified surface charge; supplying an air flow to the sized clay material in the pneumatic transfer vessel; and transferring the sized clay material from the pneumatic transfer vessel to a storage vessel.

In yet another aspect, embodiments disclosed herein relate to an apparatus for transferring a sized clay material for use in a drilling fluid that includes a pneumatic transfer vessel configured to provide a flow of chemically treated sized clay material comprising d₅₀<50 microns in size, the pneumatic transfer vessel comprising: an inlet configured to receive a flow of air; and an outlet configured to provide fluid communication with a storage vessel; and an air supply device in fluid communication with the inlet of the pneumatic transfer vessel.

Other aspects and advantages of the invention will be apparent from the following description and the appended claims.

### BRIEF DESCRIPTION OF DRAWINGS

FIG. 1 is an illustration of a pneumatic transfer device for the transfer of finely ground clay material in accordance with an embodiment of the present disclosure.

FIG. 2 is an illustration of a pneumatic transfer device for the transfer of finely ground clay material during use in accordance with an embodiment of the present disclosure.

FIG. 3 is an illustration of a pneumatic transfer device for the transfer of finely ground clay material after use in accordance with an embodiment of the present disclosure.

FIG. 4 is an illustration of a pneumatic transfer device for the transfer of finely ground clay material in accordance with an embodiment of the present disclosure.

FIG. 5 is a flowchart of a method for the transfer of finely ground clay material including addition of a chemical additive in accordance with an embodiment of the present disclosure.

FIG. 6 is a flowchart of a method for the transfer of finely ground clay material including chemical and physical treatments in accordance with an embodiment of the present disclosure.

### DETAILED DESCRIPTION

In one aspect, embodiments disclosed herein relate to methods for transferring finely ground or sized clay materials for use in, among other things, drilling fluids. More specifically, embodiments disclosed herein relate to the transfer of finely ground or sized non-hydratable clays such as attapulgite for use in, among other things, drilling fluids.

Currently, while the use of finely sized clays in drilling fluids is described in International Application No. PCT/US08/63160, which is herein incorporated by reference in its entirety, in the art, general problems still exist with post-production treatment and transference of the fine particles. Generally, as fines are stored, they have a natural tendency to self-compact. Compaction occurs when the weight of an overlying substance results in the reduction of porosity by forcing the grains of the substance closer together, thus expelling fluids (e.g., water), from the pore spaces. However, when multiple substance fines are intermixed, compaction may occur when a more ductile fine deforms around a less ductile fine, thereby reducing porosity and resulting in compaction.

Because finely ground particles (d₅₀<10 microns) have a tendency to self-compact during storage, subsequent transference of finely ground particles, as described above, poses problems to manufacturers, transporters, and end users of the fines. See D. Geldart, D, Types of Gas Fluidization, Powder Technology, 7 1973 at 285-292. Typically, fines are stored and transported in large vessels, wherein compaction is a common occurrence. Frequently, fines compact into a vessel during transport such that when the fines are ready to be unloaded, the fines have to be manually dug out of the vessel. The process of manually removing the fines is labor intensive, costly, and inefficient. Furthermore, because the vessels may be openly exposed to the air, the fines as they are removed may result in dust that may escape the vessel. As a result, a substantial portion of material may be lost during transference.

In accordance with embodiments of the present disclosure, the use of sized or micronized non-hydratable clay may be provided for use in a transfer system. Conventional attapulgite clay samples may have particle size distributions which range in their average size (i.e., d₅₀ of 64 to 161 microns). As used herein, the term “sized clay” refers to clay aggregates that have been classified by size into a desired d₅₀ range. Unless otherwise noted, all particle size ranges refer to pre-transfer values. For example, using classification equipment, a clay source may be classified by size to separate clay agreements that have an average particle size of less than 50 microns prior to their transference. Thus, in various embodiments, a sized non-hydratable clay of the present disclosure may have a d₅₀ less than about 50 microns, less than about 20 microns in another embodiment, and less than about 10 microns in yet another embodiment. One of ordinary skill in the art would appreciate that selection of a particle size distribution (i.e., from a d₅₀ less than 50, 40, 30, 20, 10 micron, for example, or any other d₅₀ value) may depend on factors such as the type (and accuracy) of equipment available, clay concentration, mud pump rates, the yield point desired, etc.

Further, one of ordinary skill in the art will appreciate that while a d₅₀<50 or 20 micron size ranges may be desirable, other size ranges (and distributions) may also be used in the methods of the present disclosure. Thus, examples of alternate size distributions may include non-hydratable clays having a d₁₀<9 microns, d₂₅<26 microns, and d₅₀<64 microns. Other exemplary embodiments may include non-hydratable clay materials having a d₉₀ ranging from 24-68 microns, a d₅₀ ranging from 10-30 microns, and a d₁₀ ranging from 3-6 microns. Further, once these particles have been incorporated for the transfer of large quantities of find grind clays, the distribution may narrow. Thus, embodiments of the present disclosure may include non-hydratable clay materials having a d₉₀ ranging from 12-24 microns, a d₅₀ ranging from 3.7-12 microns, and a d₁₀ ranging from 0.6-1.4 microns. However, those of ordinary skill in the art will realize that variations in the size of ground clay materials may vary according to the requirements of a certain wellbore fluid and/or drilling operation.

In particular embodiments, the finely ground or sized clays used in the methods of the present disclosure may include non-hydrating clays. Conventionally, two types of clays have been used to formulate a water-based wellbore fluid: bentonite (a hydrating clays) and attapulgite (a non-hydrating clay). Bentonite, a three-layer aluminum-silicate mineral, is the most widely used clay. However, its ability to hydrate through the bonding of water to its active sites, causing the expansion and dispersion of the clay particles, which in turn leads to the increase in viscosity, is negatively impacted by the presence of dissolved salts in water. Thus, its use is typically considered to be impractical in offshore applications where seawater is more readily available for use as the continuous phase than fresh water.

Attapulgite (or other non-hydratable clays), on the other hand, forms colloids which are stable in high electrolyte solutions such as seawater, and is therefore often preferred in offshore applications (or other applications where supply of fresh water is limited). Attapulgite is a hydrous magnesium aluminosilicate which is approximately spherical as opposed to the layered structure of smectite clays such as bentonite. This structure results in viscosification without hydration. Rather, viscosification of an attapulgite slurry results from shearing that elongates the clay particles into more of a needle or lathe shape, which is how this clay is typically described in the literature. When suspended in liquid, these lathes bunch together into bundles that have a haystack appearance under an electron microscope. This clay does not swell when contacted with water, so its ability to build viscosity depends upon the extent on which the colloid is sheared.

Thus, a non-hydratable clay, such as a clay having a needle-like or chain-like structure may be used for viscosification through shearing. Finely ground non-hydrating clays may be particularly desirable for use in the transfer methods disclosed herein. In various particular embodiments, the non-hydratable clay may be selected from at least one of attapulgite and sepiolite clays. While the non-hydratable clays do not substantially swell in either fresh or salt water, they may still operate to thicken salt solutions. This thickening may be attributed to what is believed to be a unique orientation of charged colloidal clay particles in the dispersion medium, and not actual “hydration.”

As the term “non-hydratable” refers to the clay's characteristic lack of swelling (i.e., a measurable volume increase) in the presence of an aqueous fluid such as salt water, a given clay's swellability in sea water may be tested by a procedure described in an article by K. Norrish, published as “The swelling of Montmorillonite,” Disc. Faraday Soc. vol. 18, 1954 pp. 120-134. This test involves submersion of the clay for about 2 hours in a solution of deionized water and about 4 percent sodium chloride by weight per volume of the salt solution. Similarly, a given clay's swellability in an aqueous fluid such as fresh water may be tested by an analogous procedure in which the sodium chloride is excluded. A “non-hydratable” clay is defined in one embodiment as one that, under this test, swells less than 8 times by volume compared with its dry volume. In another embodiment, a non-hydratable clay exhibits swelling on the order of less than 2 times; less than 0.3 times in another embodiment; and less than 0.2 times in yet another embodiment.

In further embodiments, the drilling fluids and or clay fines being transferred disclosed herein may be substantially free of hydrating clays. As used herein, “hydrating clays” is defined as those clays which swell appreciably (i.e., increase their volume by an amount of at least about 8 times) in either fresh water or salt water, and “substantially free” is defined as an amount that does not significantly affect dispersibility. Hydrating clays may include those clays which swell appreciably in contact with fresh water, but not when in contact with salt water, include, for example, clays containing sodium montmorillonite, such as bentonite. As described above, many hydrating clays have a sheet- or plate-like structure, which results in their expansion upon contact with water.

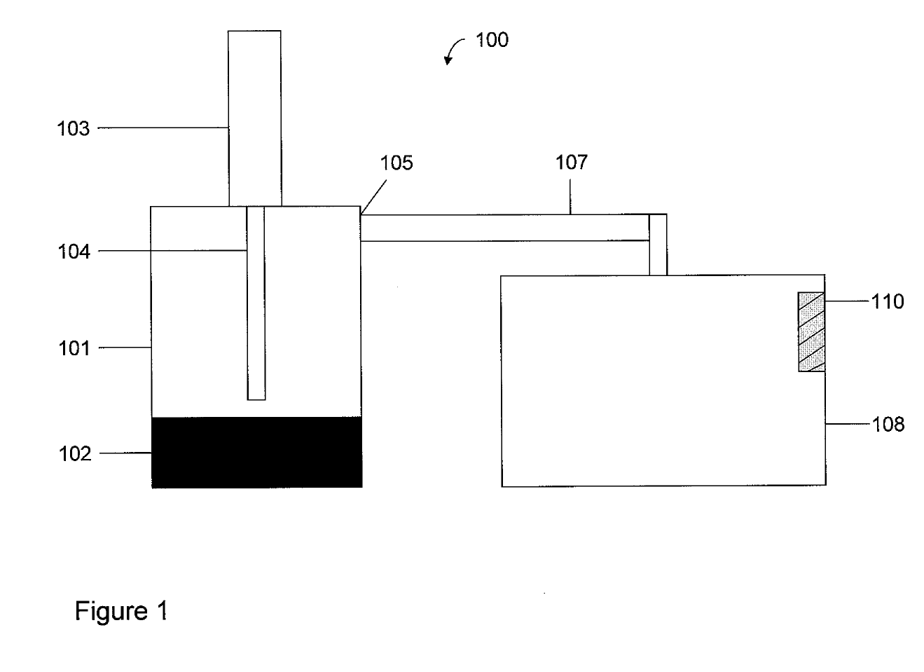

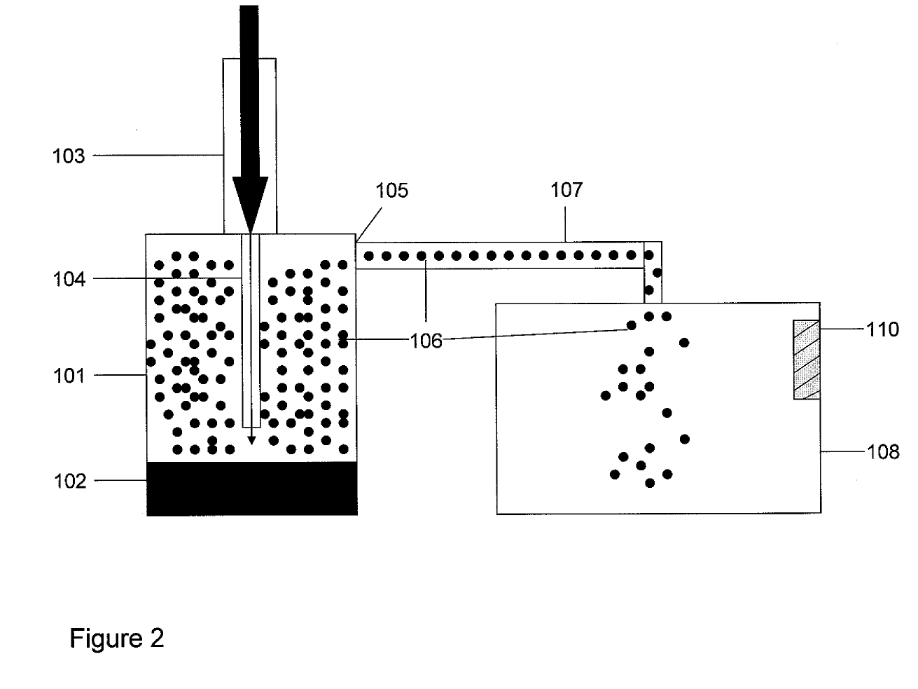

Referring initially to FIG. 1 and FIG. 2 together, a method of transferring such finely ground and classified clay particles in accordance with an embodiment of the present disclosure, is shown. In this embodiment, pneumatic transfer system 100 including a pneumatic transfer vessel 101 is shown holding a supply of fines 102 prior to transference. Pneumatic transfer vessel 101 may include an air inlet 103 and an air inlet extension 104 to supply air to the vessel. Air inlet 103 may be connected to an air supply device (e.g., an air compressor) (not shown) such that air may be directly injected into pneumatic transfer vessel 101. Pneumatic transfer vessel 101 may further include a fines exit 105.

One of ordinary skill in the art will realize that different size and shape pneumatic transfer vessels 101 may be desirable for the transference of different fines. Specifically, in one embodiment, it may be desirable to use a tall and relatively narrow pneumatic transfer vessel 101 so that air may be injected directly above a majority of the fines 102. In alternate embodiments, it may be desirable to use a short and relatively wide pneumatic transfer vessel 101 so that the distance between the fines 102 and fines exit 105 is relatively small.

In the illustrated embodiment, air inlet extension 104 protrudes from air inlet 103 into pneumatic transfer vessel 101 so that fines 102 are in close proximity to air inlet extension 104. By allowing air inlet extension 104 to inject air in close proximity to fines 102, the air may better penetrate compacted fines 102 so that better dispersion throughout pneumatic transfer vessel 101 occurs. As illustrated, air inlet extension 104 is of smaller diameter than air inlet 103. One of ordinary skill in the art will realize that by providing a smaller air inlet extension 104, the air may be focused on a smaller region of pneumatic transfer vessel 101. In alternate embodiments a directional device (not illustrated) may be attached to air inlet extension 104 so as to direct air to a specific region of pneumatic storage vessel 101. While not important in a small pneumatic transfer vessel 101, in a large vessel, wherein the diameter of air inlet extension 104 is substantially smaller than the diameter of pneumatic transfer vessel 101, the ability to direct the flow of air may allow a greater percentage of compacted fines 102 to be transferred.

As air flows into air inlet 103 through air inlet extension 104 and into pneumatic transfer vessel 101, the air contacts compacted fines 102 and results in aerated fines 106. Aerated fines 106 may flow up the sides of pneumatic transfer vessel 101 and through fines exit 105, past the exit point and into a transfer line 107 connecting pneumatic transfer vessel 101 and storage vessel 108. As air pressure increases in pneumatic transfer vessel 101, the transfer rate of aerated fines 106 may also increase, thereby forcing aerated fines 106 through transfer line 107 and into storage vessel 108. Storage vessel 108 may be any vessel capable of holding fines. However, one of ordinary skill in the art will realize that it may be desirable that storage vessel 108 is configured to prevent aerated fines 106 from escaping the system. In one embodiment, storage vessel 108 may include a sealed, vented system 110 so as to trap aerated fines in storage vessel 108 while providing an escapes means for air, so that transference occurs.

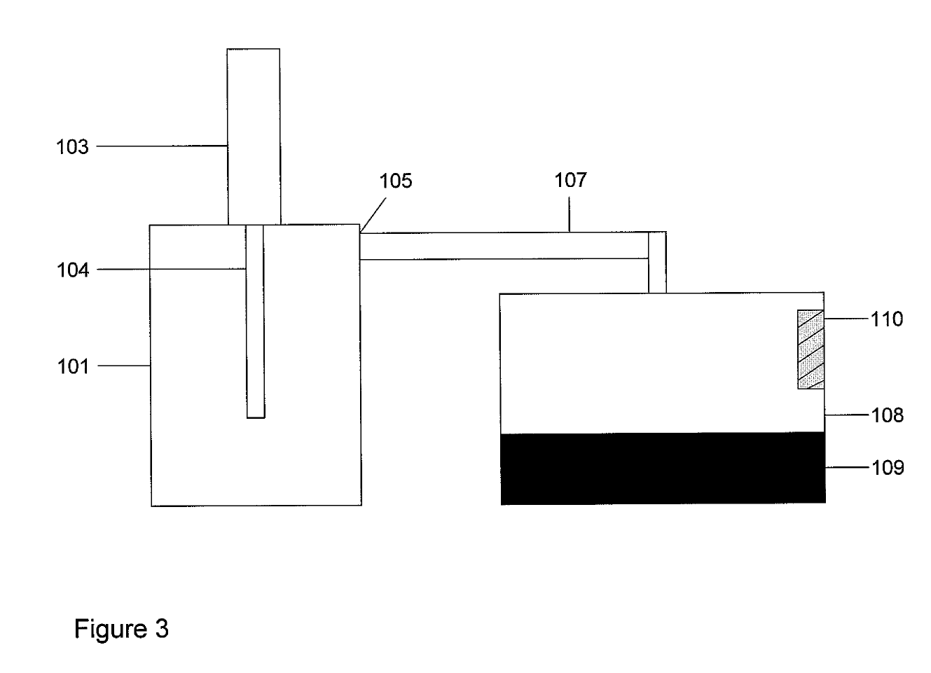

Referring now to FIG. 3, a method of transferring fines in accordance with an embodiment of the present disclosure, is shown. As described relative to FIGS. 1 and 2, as aerated fines 106 (of FIG. 2) are removed from transfer vessel 101 to storage vessel 108, the fines may settle as collected fines 109. Because collected fines 109 have undergone pneumatic transfer, such fines may remain in a less compacted form than original fines 102 during transference and/or prior to use. Thus, removal of collected fines 109 from storage vessel 108 may provide a more efficient process for transferring collected fines 109 between storage vessel 108 and where collected fines 109 are used.

During transference of the fines from transfer vessel 101 to storage vessel 108, some of the aerated fines may not recollect as collected fines 109. For example, some of the aerated fines may remain along the inner diameter of transfer vessel 101, in transfer line 107, or along any other internal component of the pneumatic transfer system. However, because the system may be configured to prevent aerated fines 106 from escaping the system, even if not all of the aerated fines 106 transfer from transfer vessel 101 to storage vessel 108, the fines remain in the system for further collection. Thus, a second pneumatic transfer cycle may be used to further transfer fines from transfer vessel 101 or any other component of the system, and the same or a different storage vessel 108 from the initial pneumatic transfer. One of ordinary skill in the art will realize that any number of pneumatic transfers may be used to reduce the amount of residual fines left from preceding transfers, thereby increasing the efficiency of such transference.

Now referring to FIGS. 1, 2, and 3 collectively, while transfer vessel 101 has been described as a vessel wherein fines 102 are stored prior to shipping, it should be noted that methods in accordance with pneumatic transfer system 100 may be used to transfer fines 102 between any vessels. For example, in one embodiment, a transfer vessel 101 may include a collection vessel for product removed from the production line. In an alternate embodiment, a transfer vessel 101 may include a vessel holding fines 102 prior to use at a drilling location and/or drilling fluid production facility. Thus, one of ordinary skill in the art will realize that the above described method for transferring fines 102 may be useful anytime fines 102 are transferred between two vessels.

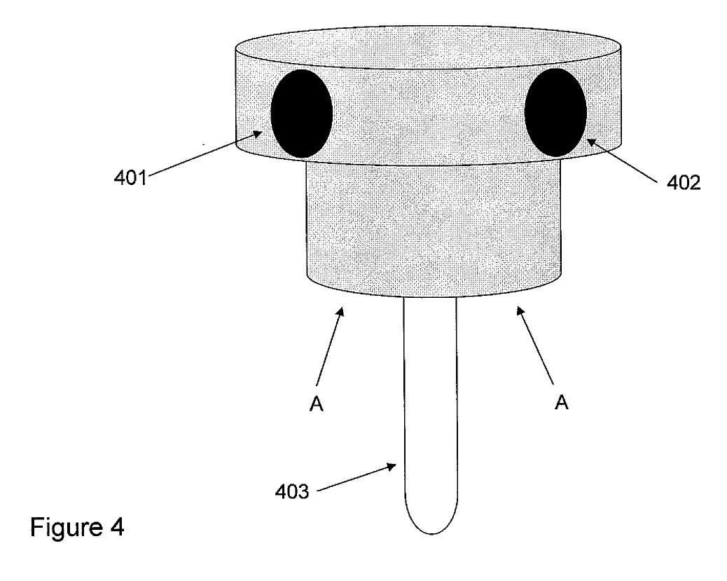

Referring now to FIG. 4, a device for transferring fines in accordance with an embodiment of the present disclosure, is shown. In view of the above, one of ordinary skill in the art will realize that systems in accordance with embodiments described herein may include retroactive attachments to preexisting systems. For example, one embodiment of the present disclosure may include a system using multiple vessels already in use for the transference of fines. In such a preexisting system, a pneumatic transfer device including a means for injecting air into one of the vessels, thereby forcing the fines into the second vessel, may be attached to one of the existing vessels. In such a system, a device including an air inlet 401, an air exit 402, and a fines exit 403 may be attached to a transfer vessel (not shown).

In this embodiment, air inlet 401 may be attached to any means for injecting air, (e.g., an air compressor). One of ordinary skill in the art will realize that it may be preferable that the air injection device (not shown) allows the pressure of air injected into air inlet 401 to be adjustable. Depending on the compaction of the fines and the content of fines additives, the air flow may be adjusted to provide the most efficient level of aeration. In certain embodiments, it may be desirable to keep the air pressure at approximately 10-20 psi. One of ordinary skill in the art will realize that applying too high of a pressure to the fines may cause the fines to further pack-off thereby preventing the aeration necessary for the pneumatic transfer of the fines. However, depending on the volume of the storage vessel, and the specifications of a given transfer operation, any pressure capable of aerating the fines in an efficient manner is within the scope of the present disclosure.

Still referring to FIG. 4, as air enters air inlet 401 at a specified pressure, internal piping (not shown) directs the air into air exit 402 and into contact with the fines in the vessel. As described above, the fines may become aerated, and as such, may be forced upwardly (illustrated as “A”) through internal piping (not shown) wherefrom the fines may exit the vessel through fines exit 403. In one embodiment, fines exit 403 may be attached to a second vessel, while in alternate embodiments, fines exit 403 may be attached to production equipment used in the production of, for example, drilling fluids.

Those of ordinary skill in the art will appreciate that the pneumatic transfer of fines may occur between varied aspects of a drilling operation. In one embodiment, fines may be pneumatically transferred between a pneumatic vessel and a storage vessel. In other embodiments, fines may be pneumatically transferred between a plurality of pneumatic vessels, or between transportation vessels and storage and/or pneumatic transfer vessels. Exemplary transportation vessels include boats and bulk storage trucks as are known in the art. In still other aspects of the disclosure, fines may be transferred at a manufacturing facility, a drilling fluid production facility, and/or a drilling location. As such, the pneumatic transference of fines may occur on both land and offshore drilling rigs.

In certain embodiments, fines may be chemically treated at a manufacturing facility and then pneumatically transferred to storage vessels. The storage vessels in such an embodiment may also be pneumatic vessels. Such pneumatic vessels may then be transported via a transportation vessel, such as a boat, to an offshore rig. After transportation to the rig, the fines may be pneumatically transferred to storage vessels on the rig, such that the fines may be used in mixing drilling fluids. In other embodiments, the transportation vessel may include a bulk storage truck. In such an embodiment, the bulk storage truck may deliver the fines to a land-based rig, such that the fines may be pneumatically transferred to storage containers at the rig, or otherwise the fines may be directly used in mixing drilling fluids. Those of ordinary skill in the art will appreciate that any number of additional pneumatic transportations may occur prior to adding the fines to a drilling fluid.

According to embodiments of the present disclosure, methods to assist in the transfer of fines may include the addition of chemical additives to the fines prior to transference. In various embodiments, dust suppressors may be used with embodiments disclosed herein including, for example, polypropylene glycol. In one embodiment, products of alkylene oxides, such as a polyols and/or polyether, may be applied to the ore as a chemical treatment prior to grinding. Polyols include diols, triols, etc, including, for example ethylene glycol, propylene glycol, and/or diethylene and di- and tri-propylene glycol. Polyethers that may be used to coat weighting agents include, for example, an alkylene oxide product, polypropylene glycol, and polyethylene glycol. In an embodiment using an alkylene oxide product in a liquid state, treating the clay ore may include, for example, spraying and/or soaking the ore with the additive.

However, in other embodiments, use of alternate chemical treatments typically associated with dust suppressors, such as, for example, alcohol alkoxylates and alkyl phenol alkoxylates (which are formed by adding an alkylene oxide to an alcohol or alkyl phenol), may be used. Additionally, other alkylene oxide condensates, such as alkylene oxide condensates of amides, amines, quaternary ammonium compounds, phosphate esters, and sulfonic acids. In another embodiment, coatings that decrease static charges between the treated particles may find particular use in embodiments of the present disclosure. Such anti-static compounds are thought to reduce buildup of static charges by making the surface of the coated material either slightly conductive either by being conductive or by absorbing moisture from the air. Such compounds may have both hydrophilic and hydrophobic portions, such that the hydrophobic side interacts with the surface and the hydrophilic side interacts with air moisture to bind water molecules. Examples of such anti-static agents include long-chain aliphatic amines (optimally ethoxylate) quaternary ammonium salts, phosphate esters, polyethylene or polypropylene glycols, and esters of polyols, polyethers, or conductive polymers. The above list of chemical treatments is merely illustrative, and as such, those of ordinary skill in the art will appreciate that alternate chemical treatments may be used according to the embodiments described herein. The specific type of chemical treatment may vary according to the requirements of a drilling operation. In certain embodiments, use of a low toxicity chemical treatment, such as monopropylene glycol, may provide a treatment that has low environmental impact properties. Furthermore, selection of such coatings may also depend upon the fluid into which the gelling agents will be added to provide for ease in dispersability of such gelling agents in a wellbore fluid after transference to a drilling location.

Alternatively, gelling agents may be coated with, for example, wetting agents, emulsifiers, solvents, anti-caking agents, and/or fillers. Typical wetting agents include fatty acids, organic phosphate esters, modified imidazolines, amidoamines, alkyl aromatic sulfates, and sulfonates. SUREWET®, commercially available from M-I LLC, Houston, Tex., is an example of a wetting agent that may be suitable for coating gelling agents as discussed herein. SUREWET® is an oil based wetting agent and secondary emulsifier that is typically used to wet fines and drill solids to prevent water-wetting of solids. Moreover, SUREWET® may improve thermal stability, rheological stability, filtration control, emulsion stability, and enhance system resistance to contamination when applied to gelling ore.

Other coatings may include, carboxylic acids of molecular weight of at least 150, polybasic fatty acids, alkylbenzene sulphonic acids, alkane sulphonic acids, linear alpha-olefin sulphonic acid or the alkaline earth metal salts of any of the above acids, and phospholipids, a polymer of molecular weight of at least 2,000 Daltons, including a water soluble polymer which is a homopolymer or copolymer of monomers selected from the group comprising: acrylic acid, itaconic acid, maleic acid or anhydride, hydroxypropyl acrylate vinylsulphonic acid, acrylamido 2-propane sulphonic acid, acrylamide, styrene sulphonic acid, acrylic phosphate esters, methyl vinyl ether and vinyl acetate, and wherein the acid monomers may also be neutralized to a salt, thermoplastic elastomers, and hydrophobic agents including saturated or unsaturated fatty acids, metal salts of fatty acids, and mixtures thereof.

In alternate embodiments of the present disclosure, methods to assist in the transfer of fines may include the addition of physical treatment to the fines prior to transference. Such physical treatments may include the use of, for example, calcium carbonate (CaCO₃). One such form of commercially available calcium carbonate is SAFE-CARB® distributed by M-I LLC, Houston, Tex. SAFE-CARB® is an acid-soluble calcium carbonate bridging and weighting agent for controlling fluid loss and density.

In view of the above, a physical treatment may be added to fines to enhance resistance to compaction. By changing the particle side distribution, fines will be less likely to compact together, thus, during transference, the fines may be more easily removed from the holding vessel or be otherwise pneumatically transferred as described above.

FIGS. 1-4 were described relative to methods and systems for the pneumatic transfer of fines; however, methods and systems for treating fines both chemically and physically prior to pneumatic transference are within the scope of the present disclosure.

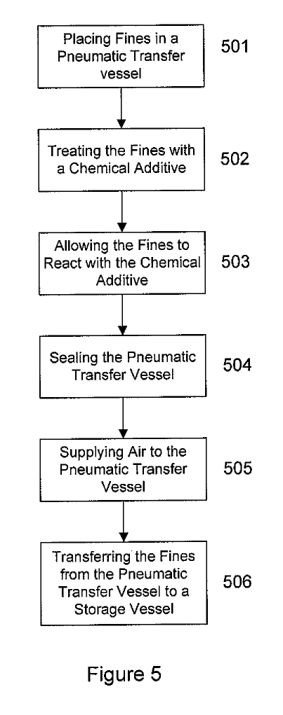

Referring now to FIG. 5, a flowchart of a method for the transfer of finely ground clay material including addition of a chemical additive in accordance with an embodiment of the present disclosure, is shown. In one embodiment, initially, fines may be placed in a pneumatic transfer vessel 501. The pneumatic transfer vessel may be any vessel capable of holding fines, and which is sealable, including any of the vessels as described above. After the transfer vessel is filled to a specified level, the fines may be treated with a chemical additive 502. The chemical additives may include any of the previously described additives, and the quantity of chemical additive will depend on the nature of the fines being transferred and the nature of the operation in which the final product will be used.

After addition of the chemical additive, the chemical additive may require a specified time to react 503 with the fines such that optimal transference conditions are achieved. Depending on the nature and quantity of the additive as well as the quantity of fines, the reaction time may be almost instantaneous, or may require several minutes to complete. One of ordinary skill in the art will also realize that in certain operations, substantially no reaction time may be required.

After allowing the fines and the chemical additives to react, the pneumatic transfer vessel should be sealed 504, so that air may flow between the pneumatic transfer vessel, the storage vessel, and/or any lines extending therefrom. By sealing the pneumatic transfer vessel, both the transfer vessel, and any lines extending therefrom should be sealed to prevent the expulsion of aerated fines. However, the storage vessel should be vented and/or configured to allow the escape of air from the system so that transference occurs. When the pneumatic transfer vessel has been sealed, a supply of air should be injected into the transfer vessel 505. The supply of air may be directional, at a specified pressure, or of any other nature such as to promote an efficient transfer of the fines from the transfer vessel to the storage vessel.

As the air contacts the fines, aerated fines may travel out of the transfer vessel, through any connecting conduits, and into the storage vessel 506. The process of fines transference may last for any time that is appropriate to transfer a desired quantity of fines. At the termination of fines transference, the air supply may be shut off, and after an appropriate settling time to ensure that all aerated fines have settled, the fines may be collected for further processing and/or use.

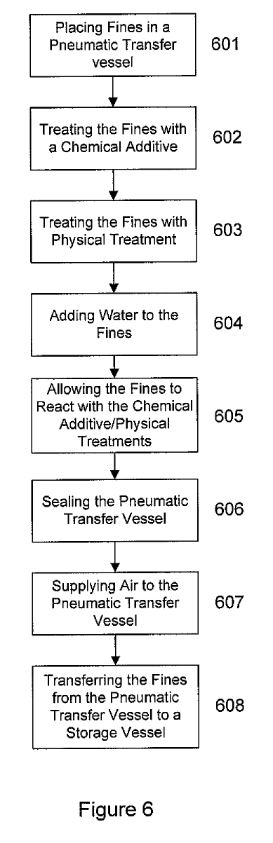

Referring now to FIG. 6, a flowchart of a method for the transfer of finely ground clay material including chemical and physical treatments in accordance with an embodiment of the present disclosure, is shown. In this embodiment, as described above, the fines may be placed in a pneumatic transfer vessel 601. After placing the fines in the pneumatic transfer vessel, the fines may be treated with a chemical additive 602. As previously described, the chemical additive may require time to react with the fines, or, depending on the nature and quantity of the reagents, the fines may be further treated with a physical treatment 603. After adding both a chemical additive and a physical treatment to the fines, a second chemical additive, or as in this embodiment, water, may be added to the fines 604. One of ordinary skill in the art will realize that any number of additional chemical additives and/or physical treatments may be added to the fines to create a mixture that will pneumatically transfer in a more efficient manner.

In this embodiment, after mixing the chemical additives and performing any physical treatments, the mixture is allowed to react 605. As discussed above, such reaction time may not be necessary, depending on the quantity and nature of the additives/treatments and the fines. Upon completion of the reaction of the mixture, the system may be configured to prevent the escape of aerated fines 606. After ensuring that fines may not escape from the system, as described above, air may be supplied to the pneumatic transfer vessel 607 to aerate the mixture and provide for the transference of fines from the transfer vessel to a storage vessel 608. Finally, after the appropriate quantity of fines has been transferred, the air supply may be removed, and after an appropriate settling time, the fines may be collected for further processing and/or use.

In still other embodiments, a chemically treated finely ground clay material is added to a pneumatic transfer vessel, a supply of air is provided to the pneumatic transfer vessel, and the finely ground clay material is transferred to a storage vessel. In such an embodiment, the chemically treated finely ground clay material may be less prone to compaction due to the coatings on the particles. The coating may thus provide for a fluidizable material that may be pneumatically transferred. Because the finely ground clay material may be fluidizable, the material may be more readily transferred between vessels.

Additionally, those of ordinary skill in the art will appreciate that the chemically treated finely ground clay material does not need to be fully fluidizable to benefit from the embodiments disclosed herein. For example, the finely ground clay material may be pneumatically transferred between vessels using a combination of pressure and pulsation air to convey the material within the vessel. In such an embodiment, a pulse of air may help free compacted material within a vessel, and then a constant or intermittent pressure may be used to convey the material between the vessels. The pulse of air may thus result in the failure of inter-particle forces that may otherwise hold the materials together in a compacted state. To further enhance the transferability of the material, a combination of pulsation and pressure may be used throughout the transference line between the vessels.

In any of the above described systems, one of ordinary skill in the art will realize that additional steps may need be performed after the transference of the fines from the transfer vessel to the storage vessel. Specifically, in systems incorporating chemical additives and/or physical treatments, the attapulgite fines may need to be further processed to remove such additives and treatments. In such embodiments of the present disclosure, the system may require additional steps of pneumatic transference so that a fine that is chemical additive free and/or physical treatment free may be produced/used.

Advantageously, embodiments of the aforementioned systems and methods may increase the transference efficiency of finely ground clay material. Pneumatic transference of fines may provide a quick and relatively less expensive method for moving fines between production lines and packaging, from packaging to shipping, from shipping to place of use, or any combinations thereof.

Because the methods may allow the transference of fines pneumatically, there is a decreased need for human labor. The pneumatic transference may replace the currently used process of manually digging out fines from shipping containers and then manually transferring them to their respective end locations. By reducing the need for manual labor, and the time associated therewith, the present disclosure provides advantage over fine transference methods known in the prior art.

Additionally, pneumatic transfer systems may remain configured to prevent the escape of aerated fines during the process of transference. Because the system may be configured to prevent the escape of aerated fines, there is less chance that fines will be exposed to environmental contamination and moisture that may further increase the compaction of fines during shipment.

Advantageously, embodiments disclosed herein may allow for the mixing of fluids for use in drilling operations that include sized gelling agents. More specifically, the pneumatic transfer of a grind clay agent of d₅₀<10 microns in size may allow for the mixing of drilling fluids formulated for specific drilling operations. The chemical treatment of sized gelling agents may thus allow for the pneumatic transfer of the gelling agents at manufacturing facilities, at drilling locations, or on transportation vessels. Furthermore, chemically treating sized gelling agents may allow for the pneumatic handling of gelling agents between varied aspects of a drilling operation including the manufacturing, drilling, and transportation sections of the operation. Furthermore, because the pneumatic transfer of such sized gelling agent allows for a more efficient transference, the costs associated with transferring and mixing fluids containing the sized gelling agents may also be decreased.

In one embodiment, a drilling engineer may produce a chemically treated sized gelling agent, for example micronized barite d₅₀<10 microns in size. The gelling agent may then be pneumatically transferred to a different aspect of the drilling operation. For example, the gelling agent may be transferred within a manufacturing facility, between a manufacturing facility and a drilling operation, between different aspects of the drilling operation, between the manufacturing facility and a transportation vessel (such as a boat), or between multiple transportation vessels. In a specific embodiment, the gelling agent may be pneumatically transferred between a transportation vessel and an offshore drilling rig. In such an embodiment, after the pneumatic transference of the gelling agent, the gelling agent may be dispersed into the fluids to produce a wellbore fluid for use at the drilling operation.

While the present disclosure has been described with respect to a limited number of embodiments, those skilled in the art, having benefit of the present disclosure, will appreciate that other embodiments may be devised which do not depart from the scope of the disclosure described herein. Accordingly, the scope of the disclosure should be limited only by the claims appended hereto.

What is claimed is:

1. A method for transferring a sized clay material for use in drilling fluids comprising:
providing the sized clay material to a pneumatic transfer vessel;
supplying an air flow to the sized clay material in the pneumatic transfer vessel; and
transferring the sized clay material from the pneumatic transfer vessel to a storage vessel.

2. The method of claim 1, wherein the sized clay material comprises attapulgite.

3. The method of claim 1, wherein the supplying the air flow comprises supplying between 10-60 psi of air to the contents of the pneumatic transfer vessel.

4. The method of claim 1, further comprising:
treating the sized clay material with a chemical additive to change the particle size distribution of the sized clay material.

5. The method of claim 1, further comprising:
treating the sized clay material with a physical treatment to change the particle size distribution of the sized clay material.

6. The method of claim 1, further comprising:
treating the sized clay material with a physical treatment and a chemical additive to change the particle size distribution of the sized clay material.

7. The method of claim 1, further comprising treating the sized clay material with a chemical additive to coat the sized clay material.

8. The method of claim 1, wherein the sized clay material comprises d₅₀<50 microns in size.

9. The method of claim 1, wherein the sized clay material comprises non-hydrating clays.

10. A method for transferring a sized clay material for use in drilling fluids comprising:
modifying a particle size distribution of the sized clay material;
sealing the sized clay material in a pneumatic transfer vessel;
supplying an air flow to the sized clay material in the pneumatic transfer vessel; and
transferring the sized clay material from the pneumatic transfer vessel to a storage vessel.

11. The method of claim 10, wherein the modifying comprises treating the sized clay material with a physical treatment.

12. The method of claim 10, wherein the modifying comprises treating the sized clay material with a chemical additive.

13. The method of claim 10, wherein the modifying comprises treating the sized clay material with a physical treatment and a chemical additive.

14. The method of claim 10, wherein the sized clay material is attapulgite.

15. The method of claim 10, wherein the sized clay material comprises non-hydrating clays.

16. A system for transferring a sized clay material for use in drilling fluids, the system comprising:
a first pneumatic vessel configured to supply a flow of chemically treated sized clay material comprising d₅₀<50 microns in size; and
a second pneumatic vessel in fluid communication with the first pneumatic vessel and configured to receive the flow of chemically treated sized clay material from the first pneumatic vessel.

17. The system of claim 16, wherein the first pneumatic vessel is disposed on a transportation vessel and the second pneumatic vessel is disposed on a drilling rig.

18. The system of claim 17, wherein the drilling rig comprises an offshore drilling rig.

19. The system of claim 16, wherein the second pneumatic vessel is configured to provide of flow of chemically treated sized clay material for dispersion in a drilling fluid.

20. The system of claim 16, wherein the sized clay material comprises non-hydrating clays.

21. A method of transferring a sized clay material, the method comprising:
providing the sized clay material to a pneumatic transfer vessel, wherein the sized clay material comprises a modified surface charge;
supplying an air flow to the sized clay material in the pneumatic transfer vessel; and
transferring the sized clay material from the pneumatic transfer vessel to a storage vessel.

22. The method of claim 21, wherein the storage vessel is disposed on a drilling rig.

23. The method of claim 21, wherein the storage vessel comprises a pneumatic vessel.

24. The method of claim 21, wherein at least one of the pneumatic transfer vessel and the storage vessel is disposed on a transportation vessel.

25. The method of claim 21, wherein the pneumatic transfer vessel is configured to transfer clay material comprising d₅₀<50 microns in size.

26. The method of claim 21, wherein the sized clay material comprises non-hydrating clays.

27. An apparatus for transferring a sized clay material for use in a drilling fluid, the apparatus comprising:
a pneumatic transfer vessel configured to provide a flow of chemically treated sized clay material comprising d₅₀<50 microns in size, the pneumatic transfer vessel comprising:
an inlet configured to receive a flow of air; and
an outlet configured to provide fluid communication with a storage vessel; and
an air supply device in fluid communication with the inlet of the pneumatic transfer vessel.

28. The apparatus of claim 27, further comprising:
an air inlet extension in fluid communication with the inlet of the pneumatic transfer vessel.

29. The apparatus of claim 28, further comprising:
a directional device coupled to the air inlet extension.

30. The apparatus of claim 27, wherein the sized clay material comprises non-hydrating clays.
